(19) United States
(12) Patent Application Publication
(10) Pub. No.: US 2021/0063827 A1
(43) Pub. Date: Mar. 4, 2021

(54) LIQUID CRYSTAL DISPLAY DEVICE

(71) Applicant: SHARP KABUSHIKI KAISHA, Sakai City (JP)

(72) Inventor: RYOHKI ITOH, Sakai City (JP)

(21) Appl. No.: 16/998,725

(22) Filed: Aug. 20, 2020

Related U.S. Application Data
(60) Provisional application No. 62/892,210, filed on Aug. 27, 2019.

(51) Int. Cl. G02F 1/1343; G02F 1/1362

(52) U.S. Cl. CPC G02F 1/134309; G02F 1/136286; G02F 2201/121; G02F 2201/123; G02F 1/13439

(57) ABSTRACT

The present invention relates to a liquid crystal display device including: a plurality of gate bus lines arranged on a substrate; a plurality of source bus lines crossing the gate bus lines; and a pixel electrode arranged in a pixel region surrounded by the gate bus lines and the source bus lines, the pixel electrode including a linear first electrode portion arranged along the gate bus lines in a plan view and a plurality of linear second electrode portions that are electrically connected to the first electrode portion and are parallel to each other, at least one slit between the plurality of linear second electrode portions being open on a source bus line side.

### CROSS-REFERENCE TO RELATED APPLICATIONS

The present application claims priority under 35 U.S.C. §119 to U.S. Provisional Patent Application No. 62/892,210 filed on Aug. 27, 2019, the contents of which are incorporated herein by reference in their entirety.

### BACKGROUND OF THE INVENTION

### Field of the Invention

The present invention relates to liquid crystal display devices.

### Background Art

Liquid crystal display devices are display devices utilizing a liquid crystal composition to display images. In a typical display mode thereof, a liquid crystal panel containing a liquid crystal composition between a pair of substrates is irradiated with light from a backlight and voltage is applied between pixel electrodes and a counter electrode (common electrode) arranged on the substrate(s) to change the alignment of liquid crystal molecules, whereby the amount of light passing through the liquid crystal panel is controlled. Such liquid crystal display devices have advantageous features such as thin profile, light weight, and low power consumption, and are therefore used in electronic devices such as televisions, smartphones, tablet PCs, and automotive navigation systems.

Techniques of controlling the alignment of liquid crystal molecules to improve the viewing angle characteristics of a liquid crystal panel have been considered. One of the techniques is to use comb electrodes, which are provided with openings (slits) formed between linear electrodes, as pixel electrodes. For example, a method of producing a liquid crystal display device disclosed in WO 2010/131495 enables production of a liquid crystal display device having excellent display properties owing to reduction in alignment defects of liquid crystal molecules which may occur around the tips of an electrode is a vertical alignment liquid crystal display device using a comb electrode for voltage application to liquid crystal molecules (WO 2010/131495, FIG. 1). JP 2010-117737 A discloses a technique of forming slits in a pixel electrode and forming, at the slit side ends of the pixel electrode, quadrangular projections that project from the pixel electrode in a substrate plane, thereby controlling the positions of nodes (singular points) of the liquid crystal alignment formed (JP 2010-117737 A, FIG. 2).

### BRIEF SUMMARY OF THE INVENTION

Comb electrodes, which are provided with openings between linear electrodes, may be a cause of low production yield because the linear electrodes have a small electrode width and thus the linear electrodes are easily disconnected during production. Here, the production yield can be increased by closing the slits such that the electrode portions at the outer edges of the closed slits conduct, electricity even when the linear electrodes are disconnected. Meanwhile, studies made by the present inventor show that the alignment of liquid crystal molecules may be instable at the ends of closed slits to generate a dark line during display of images, causing a decrease in transmittance and response speed. Also, an afterimage may be generated when a specific image is displayed.

In response to the above issues, an object of the present invention is to provide a liquid crystal display device that reduces generation of afterimages while increasing the transmittance and the response speed.

(1) One embodiment of the present invention is directed to a liquid crystal display device including: a plurality of gate bus lines arranged on a substrate; a plurality of source bus lines crossing the gate bus lines; and a pixel electrode arranged in a pixel region surrounded by the gate bus lines and the source bus lines, the pixel electrode including a linear first electrode portion arranged along the gate bus lines in a plan view and a plurality of linear second electrode portions that are electrically connected to the first electrode portion and are parallel to each other, at least one slit between the linear second electrode portions being open on a source bus line side.

(2) In an embodiment of the present invention, the liquid crystal display device includes the structure (1), and every slit is open on the source bus line side.

(3) In an embodiment of the present invention, the liquid crystal display device includes the structure (1), and a slit open on the source bus line side and a slit closed on the source bus line side are formed alternately.

(4) In an embodiment of the present invention, the liquid crystal display device includes the structure (1), (2), or (3), and further includes an auxiliary storage capacitor electrode that overlaps the pixel electrode in a plan view.

(5) In an embodiment of the present invention, the liquid crystal display device includes the structure (4), and the auxiliary storage capacitor electrode is superposed on a contact hole in a plan view and crosses, along the gate bus lines, the pixel region surrounded by the gate bus lines and the source bus lines.

(6) In an embodiment of the present invention, the liquid crystal display device includes the structure (4), and the second electrode portions each extend to a position where the second electrode portion is superposed on the auxiliary storage capacitor electrode and is not superposed on a contact hole.

(7) In an embodiment of the present invention, the liquid crystal display device includes the structure (1), (2) or (3), and further includes a planar common electrode that is arranged between the substrate and the pixel electrode and is formed from a transparent conductive material, and a metal line that is arranged in a layer different from the gate bus lines and electrically connected to the planar common electrode as being superposed on part of the planar common electrode.

The present invention can provide a liquid crystal display device that reduces generation of after images while increasing the transmittance and the response speed.

### BRIEF DESCRIPTION OF THE DRAWINGS

FIG. 1 is a schematic plan view of one pixel, showing an exemplary liquid crystal display device according to an embodiment.

FIG. 2 is a schematic plan view showing an exemplary liquid crystal display device according to the embodiment.

FIG. 3 is a schematic plan view showing an exemplary structure of the pixel electrode in FIG. 1.

FIG. 4 is a schematic cross-sectional view taken. along the line A-B in FIG. 1.

FIG. 5 is a schematic plan view of one pixel, showing another exemplary liquid crystal display device according to the embodiment.

FIG. 6 is a schematic plan view showing as exemplary structure of the pixel electrode in FIG. 5.

FIG. 7 is a schematic plan view of one pixel, showing Modified Example 1 of the liquid crystal display device according to the embodiment.

FIG. 8 is a schematic plan view of one pixel, showing Modified Example 2 of the liquid crystal display device according to the embodiment.

FIG. 9 is a schematic plan view of one pixel, showing Modified Example 3 of the liquid crystal display device according to the embodiment.

FIG. 10 is a schematic plan view of one pixel, showing Modified Example 4 of the liquid crystal display device according to the embodiment.

FIG. 11 is a schematic cross-sectional view taken along the line C-D in FIG. 10.

FIG. 12 is a schematic plan view of one pixel, showing a liquid crystal display device according to Comparative Example 1.

FIG. 13 is a schematic plan view showing the structure of the pixel electrode in FIG. 12.

### DETAILED DESCRIPTION OF THE INVENTION

Hereinafter, a liquid crystal display device according to an embodiment of the present invention is described. The embodiment, however, is not intended to limit the scope of the present invention. The design may be modified as appropriate within the range satisfying the configuration of the present invention.

The liquid crystal display device according to the embodiment of the present invention includes: a plurality of pate bus lines arranged on a substrate; a plurality of source bus lines crossing the gate bus lines; and a pixel electrode arranged in a pixel region surrounded by the gate bus lines and the source bus lines, the pixel electrode including a linear first electrode portion arranged along the gate bus lines in plan view and a plurality of linear second electrode portions that are electrically connected to the first electrode portion and are parallel to each other, at least one slit between the linear second electrode portions being open on a source bus tine side.

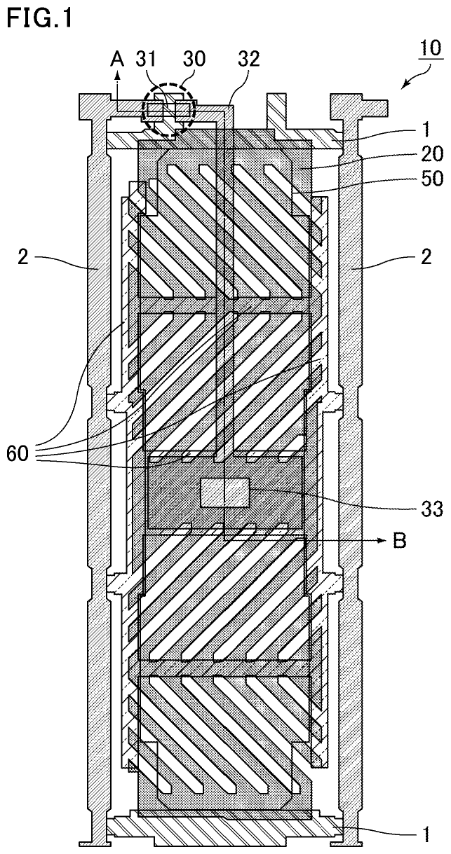

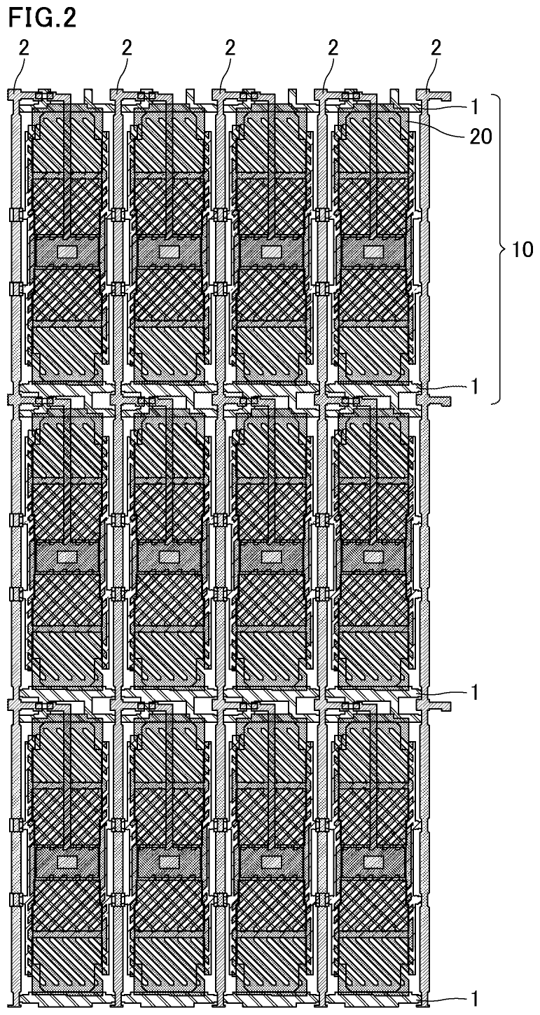

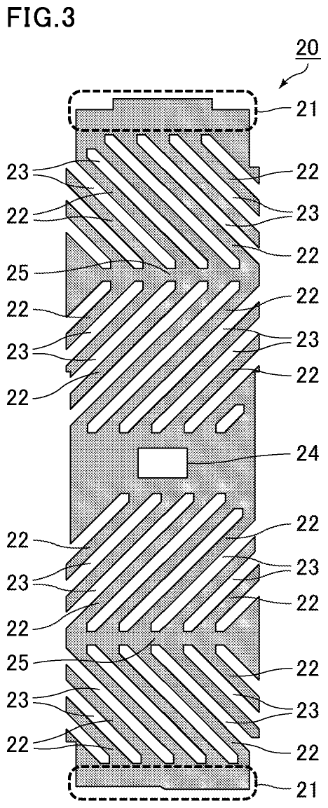

Hereinafter, an exemplary structure of the liquid crystal display device according to the embodiment of the present invention is described with reference to FIG. 1 to FIG. 3. FIG. 1 is a schematic plan view of one pixel, showing an exemplary liquid crystal display device according to an embodiment. FIG. 2 is a schematic plan view showing an exemplary liquid crystal display device according to the embodiment. FIG. 3 is a schematic plan view showing an exemplary structure of the pixel electrode in FIG. 1. The term “one pixel” as used herein means one pixel region surrounded by gate bus lines and source bus lines.

As shown in FIG. 1, the liquid crystal display device according to the embodiment of the present invention includes a plurality of gate bus lines 1 arranged on a substrate (not own) a plurality of source bus lines 2 crossing the gate bus lines 1; and a pixel electrode 20 arranged in a pixel region 10 surrounded by the gate bus lines 1 and the source bus lines 2. The pixel region 10 is a unit of display used to display an image. A thin-film transistor (TFT) 30 is arranged in a corner portion of the pixel region 10. As shown in FIG. 2, the pixel regions 10 are formed in a matrix state in the display portion of the liquid crystal display device, and a pixel electrode 20 is arranged in each pixel region 10.

As shown in FIG. 3, the pixel electrode 20 includes linear first electrode portions 21 each arranged along the gate bus lines 1 in a plan view and a plurality of linear second electrode portions 22 electrically connected to the first electrode portions 21 and parallel to each other. The expression “arranged along the gate bus lines 1” means that the linear first electrode portions 21 have only to be arranged side by side without significantly departing from the gate bus lines 1, and the extending direction of the linear first electrode portions 21 and the extending direction of the gate bus lines 1 may not be perfectly parallel to each other. The term “linear” electrode as used herein means an electrode having a certain width and a height that is orthogonal to the width and longer than the width. The linear first electrode portions 21 and the linear second electrode portions 22 may have different electrode widths and different electrode heights. Also, the linear first electrode portions 21 and the linear second electrode portions 22 may have a notch. The linear second electrode portions 22 have only to be electrically connected to the first electrode portions 21, and the connection may be direct or indirect connection. For example, the first electrode portions 21 and the second electrode portions 22 may be connected through another electrode portion constituting the pixel electrode.

The pixel electrode 20 has a structure in which pixel electrode ends are connected along the gate bus lines 1 since the linear first electrode portions 21 are each. arranged along the gate bus lines 1. In a state where the TFTs 30, which are switching elements, are, turned OFF, large negative voltage is applied to the gate bus lines 1. Liquid crystal molecules present near the gate bus lines 1 may therefore be affected by the negative voltage. This may lead to instable alignment, causing defects such as light leakage. In contrast, the liquid crystal display device according to the embodiment of the present invention has the structure in which the pixel electrode ends are connected along the gate bus lines I. The liquid crystal display device therefore can stabilize the alignment of liquid crystal molecules present near the gate bus lines 1 and reduce defects such as light leakage.

Also, at least one slit 23 between the linear second electrode portions 22 of the pixel electrode 20 is open on the source bus line 2 side. A slit 23 is an opening between the linear second electrode portions 22 and is a portion where no electrode is arranged. The expression “open on the source bus line side” means that the ends of the linear second electrode portions 22 arranged side by side with a slit 23 in between are not connected on the source bus line 2 side. In the pixel electrode 20, the electrode may be removed at a position corresponding to a contact hole 33 and an opening 24 may be formed at the position.

In the case of a liquid crystal display device using a pixel electrode with a slit closed on the source bus line side, a dark line may be generated along the source bus line due to instable alignment of liquid crystal molecules at the end of the closed slit. This may decrease the response speed of the liquid crystal molecules. Also, parasitic capacitance is formed between a source bus line and a pixel electrode. Here, a pixel electrode with a slit closed on the source bus line side has a large area superposed on the source bus line, which changes the effective value of the voltage to be actually applied to the corresponding pixel region 10 upon polarity inversion in the next frame. As a result, when the background of the display portion of the liquid crystal display device is set to have an intermediate grayscale value and a quadrangular image having a white or another single color is displayed at the center of the display portion, an afterimage of a straight line may be observed in the display portion.

In contrast, in the liquid crystal display device according to the embodiment of the present invention, at least one slit 23 is open on the source bus line 2 side. The liquid crystal display device therefore can stabilize the alignment of liquid crystal molecules around the end of the open slit 23 and around the end on the source bus line 2 side of the linear second electrode portion. 22. Thereby, the liquid crystal display device can reduce generation of dark lines due to alignment defect of liquid crystal molecules and increase the transmittance of the pixel regions 10 and the response speed of liquid crystal molecules. Furthermore, as the slit 23 is opened, the area of the pixel electrode 20 along the source bus line 2 is reduced and parasitic capacitance formed between the source bus line 2 and the pixel electrode 20 is decreased. This structure can reduce the change in effective value of the voltage to be applied to the pixel region 10 in each frame after polarity inversion and can reduce generation of an afterimage.

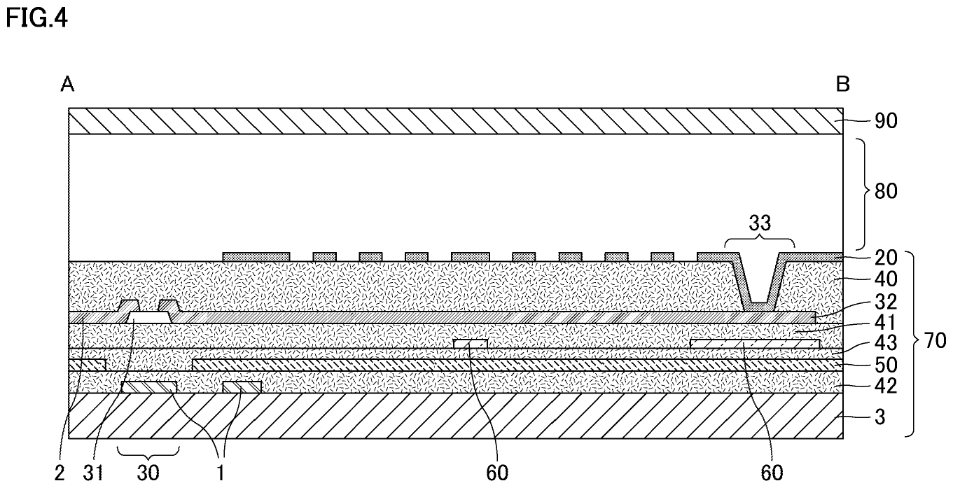

Hereinafter, exemplary structures other than the pixel electrodes are described with reference to FIG. 4 FIG. 4 is schematic cross-sectional view taken along the line A-B in FIG. 1. The liquid crystal display device according to the embodiment of the present invention includes a liquid crystal layer 80 held between a TFT substrate 70 including the TFTs 30 and a counter substrate 90.

As shown in FIG. 4, the gate bus line 1 is arranged on a substrate 3. The TFT 30 includes part of the gate bus line 1; part of the source bus line 2 arranged in a layer different from the gate bus line 1; a semiconductor layer 31; and a drain electrode 32. The pixel electrode 20 is electrically connected to the drain electrode 32 of the TFT 30 through the contact hole 33. The contact hole 33 is a conductive portion penetrating an insulating film 40 that separates the pixel electrode 20 and an underlayer conductive portion including components such as the drain electrode 32.

The substrate 3 may be any transparent substrate such as a glass substrate or a transparent resin substrate. The entire substrate, including the components such as the TFTs 31 on the substrate 3, may also be referred to as the TFT substrate 70.

The semiconductor layer 31 is not particularly limited, and can be an amorphous silicon semiconductor or an oxide semiconductor containing indium (In), gallium (Ga), and/or zinc (Zn), such as an indium gallium zinc oxide (In—Ga—Zn—O) semiconductor.

A common electrode 50 may, for example, be superposed on the pixel electrode 20 with the insulating films 40 and 41 in between. Also, an insulating film 42 may be arranged between the gate bus lines 1 and the common electrode 50. One common electrode 50 may be arranged in each pixel region 10 or may be arranged in the entire display region over a plurality of the pixel regions 10. FIG. 4 shows an example in which a planar transparent electrode is arranged in the entire display region over a plurality of the pixel regions 10. In the case where the common electrode 50 is a planar transparent electrode, the common electrode 50 is preferably not arranged in a portion superposed on the TFTs 30.

The common electrode 50 is preferably a transparent electrode, and can be formed using, for example, a transparent conductive material such as indium tin oxide (ITO) or indium zinc oxide (IZO).

The structures such as the composition and film thickness of each of the insulating films 40, 41, and 42 are not particularly limited, and may be structures typically used in the field of liquid crystal display devices.

The counter substrate 90 may be a color filter substrate including color filters. The color filter substrate may have a structure such as one including a black matrix in a region facing the gate bus lines 1 and the source bus lines 2 and color filters in regions partitioned by the black matrix. The color filters are of colors such as red (R), green (G), and blue (B).

The liquid crystal layer 80 contains liquid crystal molecules. The liquid crystal display device according to the embodiment of the present invention displays an image by changing the alignment azimuth of liquid crystal molecules in the liquid crystal layer 80. The liquid crystal molecules are not particularly limited and may be formed from a material typically used in the field of liquid crystal display devices.

An alignment film defining the initial alignment of liquid crystal molecules may be disposed between the liquid crystal layer 80 and the TFT substrate 70 and between the liquid crystal layer 80 and the counter substrate 90. The liquid crystal display device shown in FIG. 1 modulates the extending direction of the linear second electrode portion 22 of the pixel electrode 20 and the alignment treatment direction for the alignment film to divide the alignment into, for example, four domains whose alignment azimuths of liquid crystal molecules are different from one another. The number of domains in one pixel region 10 is not particularly limited, and may be, for example, 2, 4, or 8. Also, the alignment in the pixel region 10 may not be divided.

One example of the display method in the liquid crystal display device according to the embodiment of the present invention is described. When source voltage is applied to the source bus line 2, electricity is conducted through the semiconductor layer 31 (TFT is turned ON), and then voltage is applied to the pixel electrode 20 through the drain electrode 32. In the example shown FIG. 4, when voltage is applied to the pixel electrode 20, a fringe electric field is generated between the pixel electrode 20 and the common electrode 50 and the alignment azimuth of the liquid crystal molecules changes, so that an image is displayed. The TFT is turned. OFF until voltage is applied to the source electrode in the next frame. Here, is order to keep the TFT 30 in the OFF state, large negative voltage is applied to the gate bus line 1.

Hereinabove, an exemplary fringe field switching (FES) mode liquid crystal display device has been described. The display mode, however, is not limited to FES. The liquid crystal display device according to the embodiment of the present invention may be is the in-plane switching (IPS) mode. Examples of the IPS mode include a mode in which pixel electrodes and a common electrode face each other in the same plane. The common electrode also preferably includes a linear electrode portion.

A preferred mode of the liquid crystal display device according to the embodiment is described below.

Preferably, every slit is open on the source bus line side. This structure can further stabilize the alignment of liquid crystal molecules around the end of the open slit 23 and around the end on the source bus line 2 side of the linear second electrode portion 22, further increasing the transmittance of the pixel region. 10 and the response speed. The structure can also further reduce the area of the pixel electrode to reduce parasitic capacitance between the source bus line and the pixel electrode, further reducing generation of an afterimage.

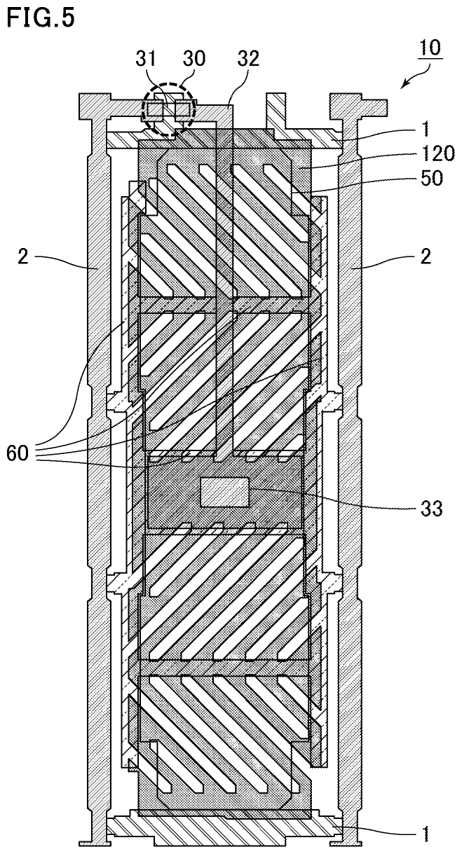

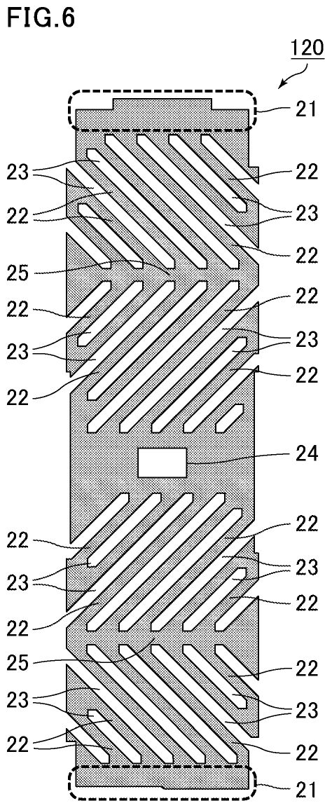

Preferably, a slit open on the source bus line side and a slit closed on the source bus line side are formed alternately. Another exemplary structure of the liquid crystal display device according to the embodiment of the present invention is described below with reference to FIG. 5 and FIG. 6. FIG. 5 is a schematic plan view of one pixel, showing another exemplary liquid crystal display device according to the embodiment. FIG. 6 is a schematic plan view showing an exemplary structure of the pixel electrode in FIG. 5. The exemplary structure of the liquid crystal display device according to the embodiment is the same as the structure in FIG. 1 except for the structure of the pixel electrodes, and thus description thereof is not repeated here.

As shown in FIG. 5 and FIG. 6, in each of the second electrode portions 22 in a pixel electrode 120, a slit 23 open on the source bus line 2 side and a slit 23 closed on the source bus line 2 side are formed alternately. In comparison with the case using pixel electrodes closed on the source bus line side, the case where the slits 23 are open on the source bus line 2 side leads to reduction in area of the pixel electrode 120 along the source bus lines 2, decreasing parasitic capacitance formed between the source bus lines 2 and the pixel electrode 120. This can reduce generation of an afterimage. Also, the alignment of liquid crystal molecules is likely to be instable in the portion where the slits 23 are closed. This structure unfortunately decreases the transmittance and the response speed but can reduce the risk of conduction failure due to breaking of the second electrode portions 22 in the production process. In consideration of the balance between the display quality and yield, the slit 23 open on the source bus line 2 side and the slit 23 closed on the source bus line 2 side are disposed alternately in each of the second electrode portions 22 in the pixel electrode 120. The pixel electrode 120 may include a third electrode portion 25 crossing the pixel along the gate bus lines. The third electrode portion 25 can connect the second electrode portions 22 adjacent to each other, and thus conduction failure tends not to occur even when one or more of the second electrode portions 22 are open-circuited.

The liquid crystal display device preferably further includes an auxiliary storage capacitor electrode that overlaps the pixel electrode in a plan view. The auxiliary storage capacitor electrode may be arranged at any position, and may be arranged at the center of a pixel region or at a position where the auxiliary capacitor electrode is superposed on another conductive line such as a gate bus line or a source bus line. With the auxiliary storage capacitor electrode not arranged at the center of a pixel region, the transmittance of the pixel region can be increased. The auxiliary storage capacitor electrode may have any shape and may have a linear shape, a quadrangular shape, a shape obtained by combining these shapes, or a planar shape. Examples of the auxiliary storage capacitor electrode include transparent electrodes such as ITO and IZO. As described below, in the case of being arranged in a region where a dark line is likely to be generated, ne auxiliary storage capacitor electrode is preferably a metal electrode formed from a metal such as chrome (Cr), molybdenum (Mo), aluminum (Al), titanium (Ti), or nickel (Ni), or an alloy material of these metals.

As shown in FIG. 4, an auxiliary storage capacitor electrode 60 may be arranged between the pixel electrode 20 and the common electrode 50. The auxiliary storage capacitor electrode 60 may not be electrically connected to the pixel electrode 20 and the common electrode 50 and may receive an electrical potential from a system different from the pixel electrode 20 and the common electrode 50. The insulating films 40 and 41 may be arranged between the auxiliary storage capacitor electrode 60 and the pixel electrode 20, and an insulating film 43 may be arranged between the auxiliary storage capacitor electrode 60 and the common electrode 50. The structures such as the composition and film thickness of the insulating film 43 are not particularly limited and may be structures typically used in the field of liquid crystal display devices.

Preferably, the auxiliary storage capacitor electrode is superposed on a contact hole in a plan view and crosses, along the gate bus lines, the pixel region surrounded by the gate bus lines and the source bus lines. The contact hole port on has a concave shape and thus is a region where the alignment of liquid crystal molecules is instable, easily generating a dark line. With the auxiliary storage capacitor electrode arranged in the region where a dark line is easily generated, generation of an afterimage can be reduced, and the display quality can be improved.

As shown in FIG. 1, the auxiliary storage capacitor electrode 60 may cross the center of the pixel region. 10. The auxiliary storage capacitor electrode 60 may be arranged near the upper ends of the pixels (the side where the TFTs 30 are arranged) along the gate bus lines. The center portion of a pixel region 10 and the upper ends of the pixel along the gate bus lines are boundary portions where the alignment azimuth of liquid crystal molecules changes, so that a dark line likely to be generated. Arranging the auxiliary storage capacitor electrode in the regions where a dark line tends to be generated enables reduction of afterimages, improving the display quality.

As shown in FIG. 1, the auxiliary storage capacitor electrode 60 may be arranged around the outer edge of a pixel along the source bus lines 2. This arrangement can reduce parasitic capacitance between the source bus lines 2 and the pixel electrode 20 to reduce delay in the source bus lines 2, thereby improving the display quality.

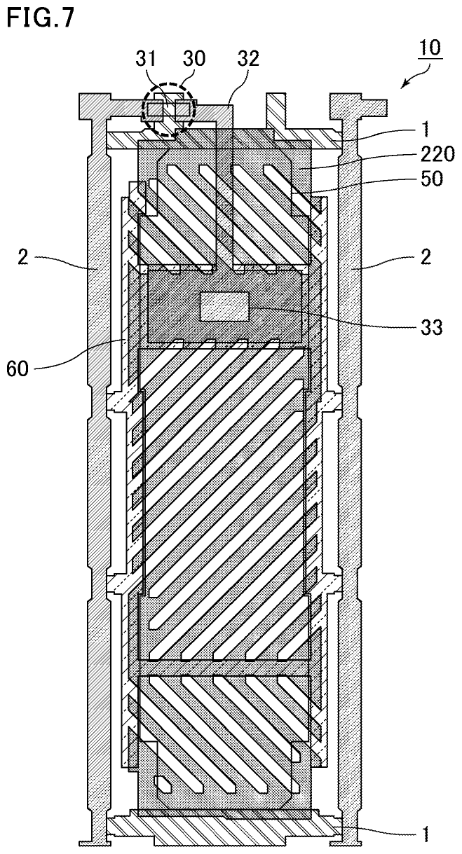

As shown in FIG. 7, the auxiliary storage capacitor electrode 60 may be arranged near the end of the pixel region 10. FIG. 7 is a schematic plan view of one pixel, showing Modified Example 1 of the liquid crystal display device according to the embodiment. This structure with the auxiliary storage capacitor electrode 60 arranged near the pixel region 10 can shorten the length of the drain electrode 32 and further increase the transmittance of the pixel region 10.

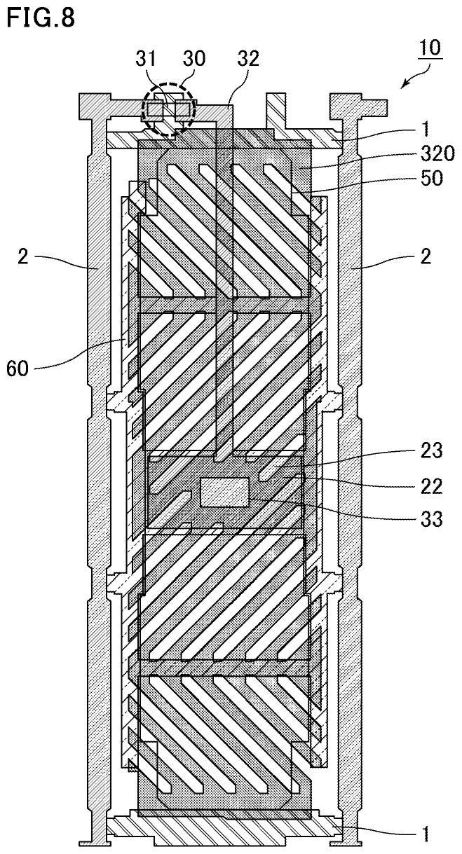

Preferably, the second electrode portions each extend to a position where the second electrode portion is superposed on the auxiliary storage capacitor electrode and is not superposed on the contact hole. FIG. 8 is a schematic plan view of one pixel, showing Modified Example 2 of the liquid crystal display device according to the embodiment. As described above, the alignment of liquid crystal molecules is instable at the ends of a closed slit and thus a dark line tends to be generated. Thus, a dark line observed protrudes from the auxiliary capacitor line in a plan view when the linear second electrode portions 22 and the auxiliary capacitor line are not superposed on each other. As shown in FIG. 8, with the linear second electrode portions 22 of a pixel electrode 320 each.

extending to a position where the linear second electrode portion 22 is superposed on the auxiliary storage capacitor electrode 60 and is not superposed on the contact hole 33, the slits 23 can also be extended to positions near the contact hole 33. Thereby, a dark line generated at the closed end of a slit 23 can be transferred to a region where the linear second electrode portion 22 is superposed on the auxiliary storage capacitor electrode 60. Thereby, the transmittance and the response speed can be increased. Also, extending the slit 23 leads to reduction of the area of the pixel electrode 20, reducing parasitic capacitance between the source bus line 2 and the pixel electrode 20. This reduces generation of an afterimage.

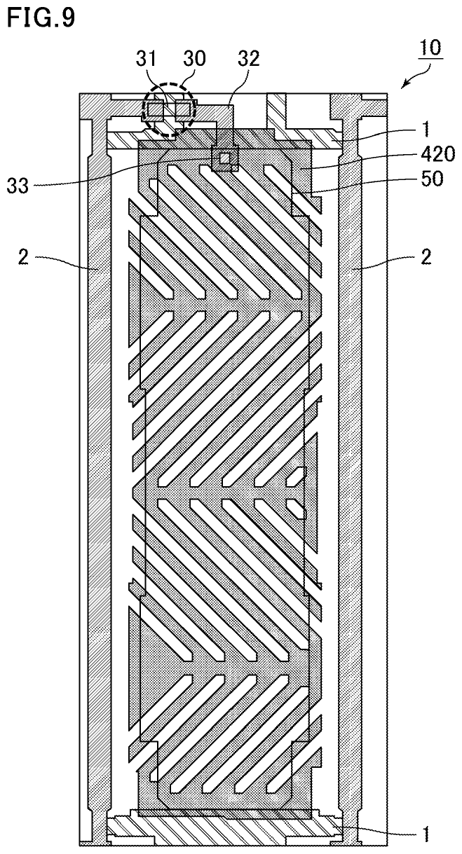

Meanwhile, the liquid crystal display device may not include an auxiliary storage capacitor electrode from the viewpoint of increasing the transmittance of pixels. FIG. 9 is a schematic plan view of one pixel, showing Modified Example 3 of the liquid crystal display device according to the embodiment. As shown in FIG. 9, in Modified Example 3, no auxiliary storage capacitor electrode is arranged inside the pixel region, so that the transmittance of the pixel region can be increased. Also, since the drain electrode 32 is arranged along the gate bus line 1 in FIG. 9, the transmittance can be further increased.

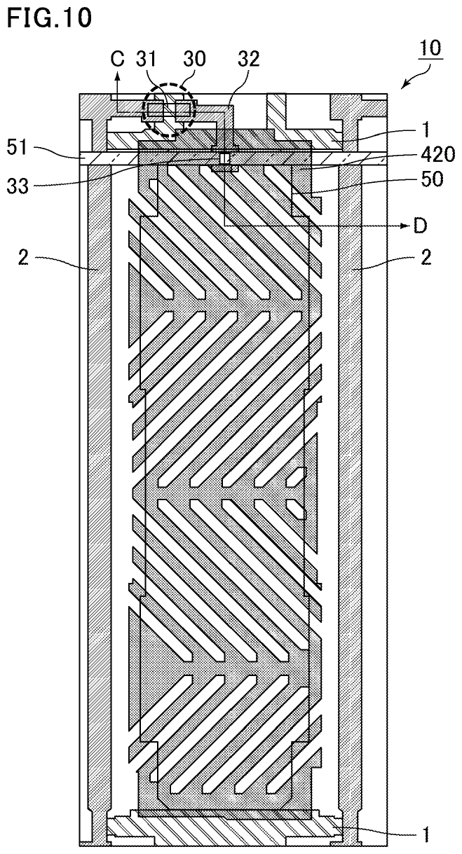

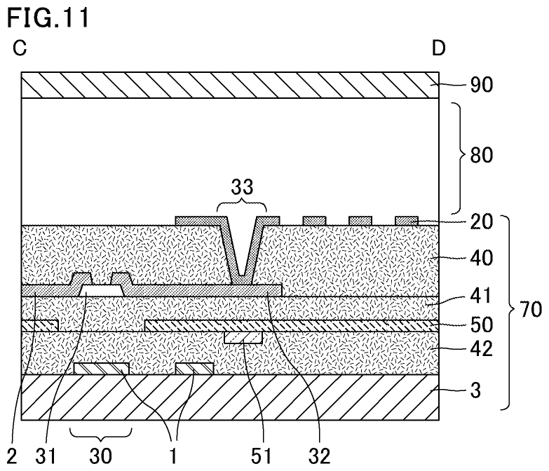

Preferably, the liquid crystal display device further includes a planar common electrode that is arranged between the substrate and the pixel electrode and is formed from a transparent conductive material, and a metal line that is arranged in a layer different from the gate bus lines and electrically connected to the planar common electrode as being superposed on part of the planar common electrode. FIG. 10 is a schematic plan view of one pixel, showing Modified Example 4 of the liquid crystal display device according to the embodiment. FIG. 11 is a schematic cross-sectional view taken along the line C-D in FIG. 10.

Examples of the transparent conductive material include indium tin oxide (ITO) and indium zinc oxide (IZO).

A metal line 51 may be any metal that has a lower resistance than the transparent conductive material, and examples thereof include copper titanium (Ti), and silver (Ag).

Materials such as ITO and. IZO have a high resistance. Thus, the resistance of the common electrode 50 can be decreased by arranging the metal line 51 such that the metal line 51 is superposed on part of the planar common electrode 50 as shown in FIG. 11, thereby electrically connecting the metal line 51 to the common electrode 50. A decrease in resistance of the common electrode 50 reduces the voltage difference between the upper and lower regions or between the left and light regions in the display portion of the liquid crystal display device a result, the difference in luminance is reduced between the upper and lower regions or between the left and light regions in the display portion, so that the display quality can be improved.

Preferably, the metal line 51 is superposed on the contact hole 33 in a plan view. Since the contact hole 33 has a concave shape and the alignment of liquid crystal molecules therearound is instable, the region is preferably shielded from light. Superposing the metal line 51 on the contact hole 33 enables the region around the contact hole 33 to be shielded from light without decreasing the pixel aperture ratio as compared with the case where the metal line 51 is arranged at a different position. Although, the metal line 51 is arranged in the lower layer (on the substrate 3 side) of the common electrode 50 in FIG. 11, the metal line 51 may be arranged in the upper layer (on the liquid crystal layer 80 side) of the common electrode 50.

The present invention will be described in more detail based on the following examples. The examples, however, are not intended to limit the scope of the present invention.

### Example 1

Example 1 is one specific example of the liquid crystal display device according to the embodiment shown in FIG. 1 to FIG. 4. In a pixel region 10A in Example 1, generation of dark lines was reduced in the portion of a slit open on the source bus line side, and the transmittance of the pixel region 10A increased along the source bus lines.

### Example 2

Example 2 is one specific example of the liquid crystal display device according to the embodiment shown in FIG. 5 and FIG. 6. In a pixel region 10B in Example 2, generation of dark lines was reduced in the portion of a slit open on the source bus line side, and the transmittance of the pixel region 10B increased along the source bus lines, although not as much as the increase in Example 1.

### Example 3

Example 3 is one specific example of Modified Example 2 of the liquid crystal display device according to the embodiment shown in FIG. 8. In a pixel region 10C in Example 3, generation of dark lines was reduced in the portion of a slit open on the source bus line side and in the vicinity of the auxiliary storage capacitor electrode arranged is the center of the pixel, and the transmittance of the pixel region 10C increased along the source bus lines and in the vicinity of the auxiliary storage capacitor electrode.

### Comparative Example 1>

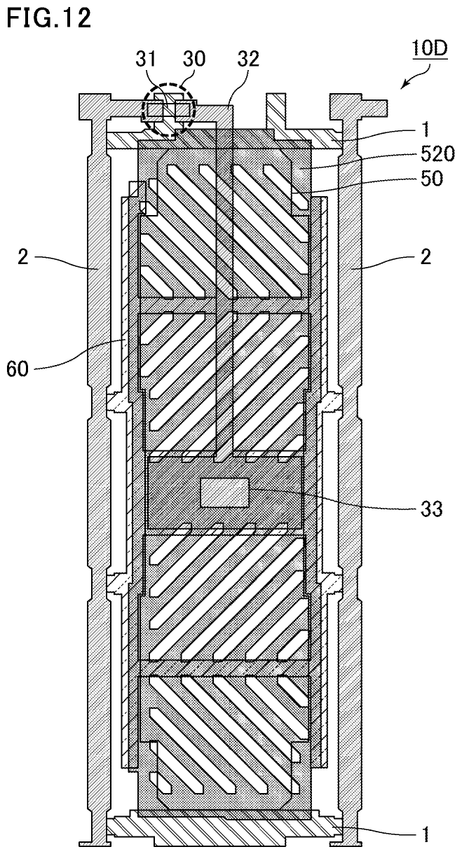

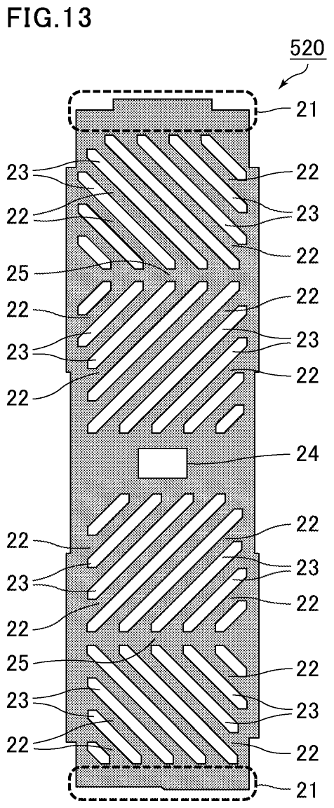

FIG. 12 is a schematic plan view of one pixel, showing a liquid crystal display device according to Comparative Example 1. FIG. 13 is a schematic plan view showing the structure of the pixel electrode in FIG. 12. The liquid crystal display device in Comparative Example 1 has the same configuration as that in Example 1, except for the pixel electrode structure. The liquid crystal display device according to Comparative Example 1 has a configuration in which, as shown in FIG. 12 and FIG. 13, a pixel electrode 520 includes a plurality of linear electrode portions and slits are closed along both gate bus lines and source bus lines. In a pixel region 10D in Comparative Example 1, dark lines generated along the gate bus lines and the source bus lines, and thus the transmittance of the pixel region 10D was low.

What is claimed is:

1. A liquid crystal display device comprising:
a plurality of gate bus lines arranged on a substrate;
a plurality of source bus lines crossing the gate bus lines; and
a pixel electrode arranged in a pixel region surrounded by the gate bus lines and the source bus lines,
the pixel electrode including a linear first electrode portion arranged along the gate bus lines in a plan view and a plurality of linear second electrode portions that are electrically connected to the first electrode portion and are parallel to each other,
at least one slit between the linear second electrode portions being open on a source bus line side.

2. The liquid crystal display device according to claim 1,
wherein every slit is open on the source bus line side.

3. The liquid crystal display device according to claim 1,
wherein a slit open on the source bus line side and a slit closed on the source bus line side are formed alternately.

4. The liquid crystal display device according to claim 1, further comprising an auxiliary storage capacitor electrode that overlaps the pixel electrode in a plan view.

5. The liquid crystal display device according to claim 4,
wherein the auxiliary storage capacitor electrode is superposed on a contact hole in a plan view and crosses, along the gate bus lines, the pixel region surrounded by the gate bus lines and the source bus lines.

6. The liquid crystal display device according to claim 4,
wherein the second electrode portions each extend to a position where the second electrode portion is superposed on the auxiliary storage capacitor electrode and is not superposed on a contact hole.

7. The liquid crystal display device according to claim 1, further comprising
a planar common electrode that is arranged between the substrate and the pixel electrode and is formed from a transparent conductive material, and
a metal line that is arranged in a layer different from the gate bus lines and electrically connected to the planar common electrode as being superposed on part of the planar common electrode.
